(19) United States
(12) Patent Application Publication
(10) Pub. No.: US 2002/0094796 A1
(43) Pub. Date: Jul. 18, 2002

(54) Phase detector circuit and method therefor

(76) Inventors: Donnie W. Woods, Thousand Oaks, CA (US); Craig K. Northrup, Camarillo, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/759,654

(22) Filed: Jan. 12, 2001

(51) Int. Cl. H04B 1/06

(52) U.S. Cl. 455/260; 455/265

(57) ABSTRACT

A phase detector having improved dynamic range, frequency range, multiplication factor range, and detector gain. The detector converts a reference signal into a square wave. The square wave signal causes a step recovery diode in a sampling phase detector to trigger on a leading edge to obtain a more consistent and more precise sampling of an oscillator signal. The phase detector includes a saturated amplifier to convert the reference signal to a square wave signal, a transformer to impedance match the amplifier with the sampling phase detector and to generate a balanced output of the square wave signal. The sampling phase detector generates a phase error signal indicative of the phase difference between the reference signal and the oscillator signal. The sampling phase detector includes balanced outputs having oppositely-phased phase error signals. A potentiometer is provided to reduce or eliminate any imbalances in the oppositely-phased phase error signals.

### FIELD OF THE INVENTION

This invention relates generally to radio frequency (RF)/microwave/millimeterwave circuits, and in particular, to a phase detector circuit and method therefor having improved dynamic range, frequency range, multiplication factor range, and detector gain.

### BACKGROUND OF THE INVENTION

Dielectric resonator oscillators (DROs) are used extensively in the wireless communications field. In particular, DROs are used as local oscillators for down-converting a radio frequency (RF)/microwave/millimeterwave signal to a lower frequency intermediate or baseband signal, and for up-converting an intermediate or baseband signal to a higher RF/microwave/millimeterwave signal. DROs are preferred over other types of oscillators because DROs have improved phase noise characteristics and are capable of achieving such improved characteristics at relatively high frequencies, such as at 20 GHz or above.

Although the phase noise of the output of a DRO is relatively low, there is still room for improvements. Some of the total phase noise of the output of a DRO is generated within the DRO itself. Other phase noise contributions come from the phase-locked loop circuit. In particular, the main phase noise culprit in a phase-locked loop circuit is the phase detector. For RF/microwave/millimeterwave applications, a sampling phase detector is used for improved phase noise performance and where the direct output frequency of the DRO (e.g. up to and above 20 GHz) is many times higher than the reference frequency (e.g. 2.5 MHz) with which its phase is being compared.

In a sampling phase detector, a step recovery diode is provided which is responsive to the reference frequency in a manner that permits the sampling of the DRO output frequency at a particular phase angle of the reference frequency. Schottky diodes are provided to mix the DRO output with the reference in order to generate a phase error signal. In prior art sampling phase detectors, the reference applied to the sampling phase detector is generally sinusoidal. Because the change in phase of a sinusoidal signal is generally gradual, the triggering of the step recovery diode for the purpose of sampling the DRO output is not that precise. As a result, this imprecision contributes to phase noise at the output of the DRO. Also, the gradually changing sinusoidal reference signal causes the step recovery diode to produce a wider sampling pulse, thereby sampling the DRO output signal for a longer period, which results in a lower detector gain. The typically wider sampling pulse width produced by prior art limits the allowable frequency range of the reference and the multiplication range of the sampling phase detector.

Another drawback of the prior art sampling phase detector again stems from the reference signal being subject to variations. For example, the reference amplitude may vary due to temperature variations, vibrations, bias voltage noise, and other factors. Variation in the reference amplitude affects the timing of when the step recovery diode of the sampling phase detector is triggered for sampling the DRO output. Since the sampling time varies with variation in the reference amplitude, the triggering of the SRD pulse occurs at different times during the cycles of the reference sinusoidal waveform, the phase comparison is not as consistent, and consequently contributes to the phase noise at the DRO output.

Thus, there is a need for a phase detector circuit and method therefor that provides improved dynamic range, frequency range, multiplication factor range, and detector gain. This need and others are met with the new and improved phase detector circuit and method therefor in accordance with the invention.

### SUMMARY OF THE INVENTION

An aspect of the invention relates to a phase detector and method of phase detecting which provides improved dynamic range, frequency range, multiplication factor range, and detector gain. The phase detection methodology of the invention involves converting a sinusoidal reference signal into a square wave prior to it being applied to a sampling phase detector. The square wave reference signal can cause the step recovery diode of the sampling phase detector to trigger on the leading edge. Because the leading edge of the square wave can trigger the step recovery diode relatively fast and at substantially the same point in time relative to the start of the rising edge of the square wave, the timing of the sampling of the DRO output is much more accurate. This results in a substantially reduced phase noise contribution at the output of the DRO. Also, the relatively fast triggering of the step recovery diode results in a shorter sampling period of the DRO output signal, resulting in a higher detector gain. The shorter sampling period results from a narrower sampling pulse width. The narrower sampling pulse width allows a wider frequency range and a wider multiplication range for the sampling phase detector.

More specifically, the phase detector of the invention comprises one or more saturated amplifiers to convert the reference signal to a substantially square wave signal. The advantage of using saturated amplifiers to convert the reference signal to a square wave signal is that it expands the reference signal's dynamic range. In other words, the output of the saturated amplifier is substantially invariant with variations in the amplitude of the reference signal. The phase detector further comprises a transformer to better impedance match the output of the saturated amplifier to the input of a sampling phase detector. The transformer also generates balanced outputs having oppositely-phased square wave signals that are applied to the sampling phase detector. The sampling phase detector generates a phase error signal indicative of the phase difference between the reference signal and an output of an oscillator. The sampling phase detector includes balanced outputs having oppositely-phased phase error signals. A potentiometer is provided at the output of the phase detector to reduce or eliminate any imbalances in the amplitudes of the oppositely-phased error signals.

Other aspects of the invention relate to a local oscillator, a receiver and a transmitter that uses the phase detector of the invention. Other aspects, features and techniques of the invention will become apparent to one skilled in the relevant art in view of the following detailed description of the invention.

### BRIEF DESCRIPTION OF THE DRAWINGS

FIG. 1 illustrates a block diagram of an exemplary phase detector in accordance with the invention;

FIG. 2 illustrates a block diagram of an exemplary local oscillator using a phase detector circuit in accordance with the invention;

FIG. 3 illustrates a block diagram of an exemplary receiver using a phase detector circuit in accordance with the invention; and

FIG. 4 illustrates a block diagram of an exemplary transmitter using a phase detector circuit in accordance with the invention.

### DETAILED DESCRIPTION OF THE INVENTION

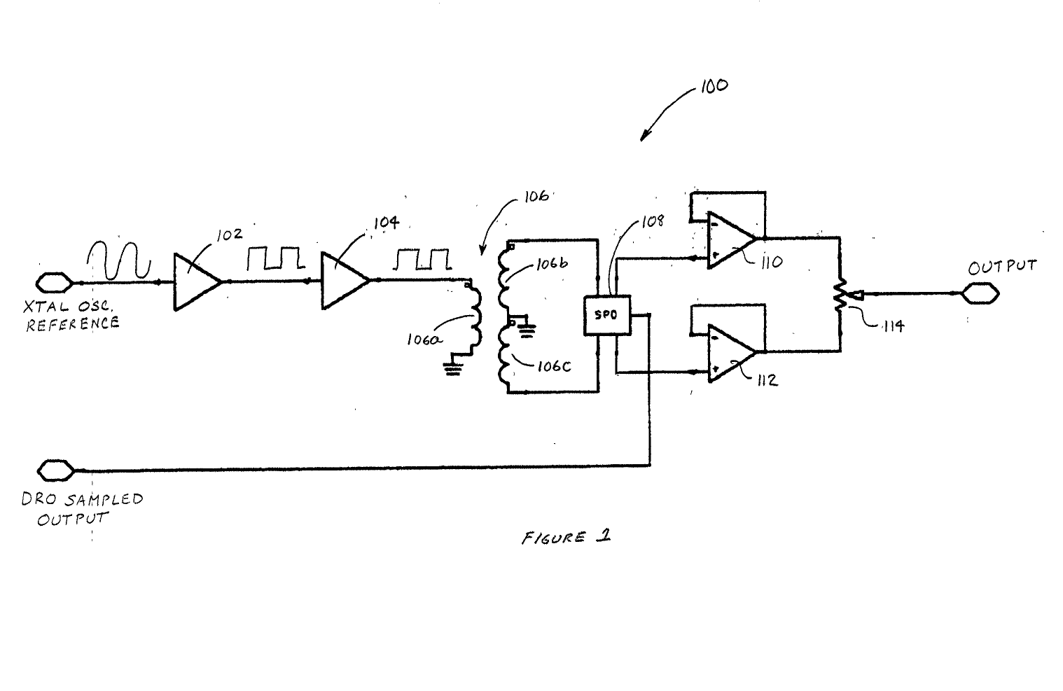

FIG. 1 illustrates a block diagram of an exemplary phase detector 100 in accordance with the invention. The phase detector 100 comprises a first stage amplifier 102, a second stage amplifier 104, and a transformer 106 having a primary winding 106a and a pair of secondary windings 106b-c. The reference signal for the phase detector 100 is applied to the input of the first-stage amplifier 102. The output of the second-stage amplifier 104 is coupled to an end of the primary winding 106a, whereas the other end of the primary winding 106a is grounded. The secondary windings 106b-c include a grounded center tap and are wound in opposite directions.

The phase detector 100 further comprises a sampling phase detector 108 having inputs coupled to respective ends of the secondary windings 106b-c of the transformer 106. The sampling phase detector 108 also includes an input for receiving the sampled output from a dielectric resonator oscillator (DRO) or another type of RF/microwave/millimeterwave oscillator. The sampling phase detector 108 further includes two outputs being respectively coupled to a pair of buffer amplifiers 110 and 112. The outputs of the buffer amplifiers 110 and 112 are respectively coupled to opposite ends of potentiometer 114, whereby the output of the sampling phase detector 100 is taken off the wiper contact of the potentiometer 114.

As previously discussed, there are several drawbacks with prior art phase detectors stemming from having the reference sinusoidal signal being applied directly to the sampling phase detector. For instance, the triggering of the step recovery diode in the sampling phase detector is not as precise using a sinusoidal signal due to the gradual change of the waveform amplitude. This, in turn, results in a phase noise contribution to the DRO output. Also, the gradually changing sinusoidal reference signal causes the step recovery diode to produce a wider sampling pulse, thereby sampling the DRO output signal for a longer period, which results in a lower detector gain. The typically wider sampling pulse width produced by prior art limits the allowable frequency range of the reference and the multiplication range for prior art sampling phase detectors.

Further, the prior art phase detector has a relatively small dynamic range for the reference amplitude due to the reference signal being applied directly to the sampling phase detector. Thus, variation in the reference amplitude affects the timing of when the step recovery diode of the sampling phase detector is triggered for sampling the DRO output. Since the timing of the sampling varies with the variation in the reference amplitude, the phase comparison is not as consistent as is desired, and consequently contributes to the phase noise at the DRO output. Variations in the reference amplitude generally translate to a phase noise contribution at the DRO output.

In order to improve on the above-mentioned drawbacks, the phase detector 100 of the invention converts the sinusoidal reference signal into a square wave prior to it being applied to the sampling phase detector 108. The square wave reference signal can cause the step recovery diode of the sampling phase detector 108 to trigger on a leading edge. Because a leading edge of the square wave can trigger the step recovery diode relatively fast and at substantially the same point in time relative to the start of the rising edge of the square wave, the sampling of the DRO sampled output signal is much more accurate. This results in substantially less phase noise contribution at the output of the DRO. Also, the relatively fast triggering of the step recovery diode results in a smaller sampling period of the DRO output, resulting in a higher detector gain. The shorter sampling period results from a narrower sampling pulse width. The narrower sampling pulse width allows a wider frequency range and a wider multiplication range for the sampling phase detector.

Another advantage of the phase detector 100 of the invention is that it allows a much wider dynamic range for the amplitude of the reference signal. This advantage is attributed to the phase detector 100 having one or more saturated amplification stages 102 and 104 to convert the sinusoidal reference signal into a substantially square wave signal. Because the amplifiers 102 and 104 are in saturation, the amplitude of the square wave signal at their outputs is less susceptible to variations in the amplitude of the reference signal. Thus, the phase detector 100 of the invention can allow more variations in the amplitude of the reference signal, i.e. giving it a wider dynamic range. An automatic gain circuit (AGC) can also be provided to ensure that the signal applied to the sampling phase detector 108 is substantially square-wave, to compensate for amplitude variations of the reference signal.

In addition, the signal applied to the sampling phase detector 108 need not be square-wave, but can be any periodic signal that includes a rising and/or falling edge. For example, a saw-tooth signal, a non-50 percent duty cycle square wave signal, etc.

Referring again to FIG. 1, the first amplifier stage 102 is a relatively high gain amplification stage to increase the amplitude of the sinusoidal reference signal sufficiently high to cause saturation of the first amplifier stage 102. Being in saturation, the first amplifier stage 102 essentially converts the sinusoidal reference signal into a substantially square wave signal. Also being in saturation, the output of the first amplifier stage 102 is less prone to amplitude variations with amplitude variations of the sinusoidal reference signal. The second amplifier stage 104 is a linear power amplifier that is current limited to lower the compression point and enhance the rise time and harmonic content of its output square wave signal, but with sufficient output voltage to trigger the step recovery diode of the sampling phase detector.

The output of the second amplifier stage 104 is converted to a balanced output to better drive the step recovery diode of the sampling phase detector 108. Accordingly, the transformer 106 generates a balanced output at its secondary windings 106b-c. In addition, the transformer 106 serves to convert the output impedance of the second amplifier stage 104 to a lower impedance value to better match the impedance of the sampling phase detector 108. For example, the transformer 106 may have a 2:1 turns ratio to convert the approximate 50 ohms output impedance of the second amplifier stage 104 to 12.5 Ohms, which better matches the inputs of the sampling phase detector 106. Preferably, the transformer 106 should have a low insertion loss and relatively high bandwidth so as not to degrade the rise time and harmonic-rich content of the square wave signal. Alternatively, in lieu of the transformer 106, the amplifier 104 may be configured to have a balanced output with an output impedance that better matches the inputs of the sampling phase detector 108.

The outputs of the sampling phase detector 108 are respectively provided to the inputs of buffer amplifiers 110 and 112. Preferably, the buffer amplifiers 110 and 112 are operational amplifiers configured as voltage-followers. The operational amplifiers 110 and 112 preferably have a relatively high input impedance (e.g. 10 Mohms), a relatively low output impedance (e.g. 10 Ohms), a relatively high slew rate, and low noise characteristics. The outputs of the buffer amplifiers 110 and 112 are coupled respectively to opposite ends of the potentiometer 114, whereby the wiper contact of the potentiometer serves as the output of the phase detector 100. The potentiometer 114 serves to eliminate or at least reduce any amplitude imbalances in the outputs of the sampling phase detector 108.

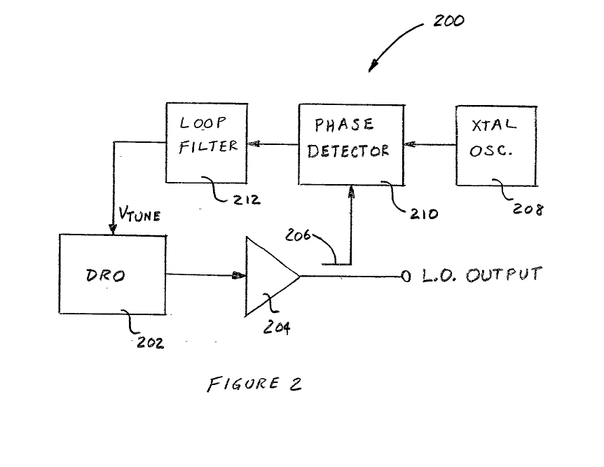

FIG. 2 illustrates a block diagram of an exemplary local oscillator 200 using a phase detector circuit in accordance with the invention. The local oscillator 200 comprises a DRO 202 (which can also be any type of tunable RF/microwave/millimeterwave oscillator), an optional amplifier 204 (or other isolating device such as an attenuator pad, or isolator), a coupler 206, a crystal oscillator 208, a phase detector 210 of the invention (such as the exemplary embodiment shown in FIG. 1), and a loop filter 212. The DRO 202 generates a relatively low phase noise LO signal which is amplified by optional amplifier 204. A portion of the amplified LO signal is coupled to the phase detector 210 by the coupler 206. The phase detector 210 compares the phase of the reference signal from the crystal oscillator 208 to the phase of the sampled LO signal, and generates a phase error signal. The phase error signal is applied to the loop filter 212 to filter out unwanted frequency components so as to generate the tuning voltage V_{TUNE} for the DRO 202 to maintain the DRO output within a frequency specification.

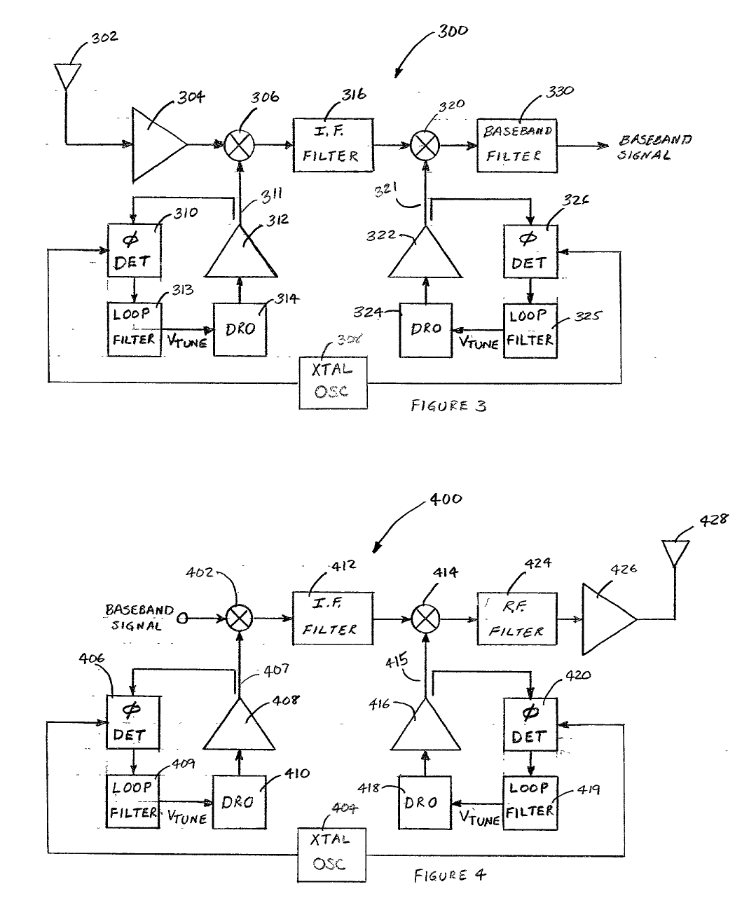

FIG. 3 illustrates a block diagram of an exemplary receiver 300 using a phase detector in accordance with the invention. The phase detector 100 of the invention can be used in many applications, even as part of the receiver 300. The receiver 300 comprises a low noise amplifier 304 having an input for receiving an RF/microwave/millimeterwave signal from an antenna 302 or other transmission source. The output of the low noise amplifier 304 is coupled to a first down-converting stage comprising a first mixer 306 and a first local oscillator (LO) comprising DRO 314, optional amplifier 312, directional coupler 311, phase detector 310 (e.g. like phase detector 100), a reference crystal oscillator 308, and a loop filter 313. The output of the DRO 314 is coupled to the input of the optional amplifier 312 for increasing the power of the local oscillator signal sufficiently to drive the mixer 306. The output of optional amplifier 312 is coupled to the input of the directional coupler 311 to provide a portion of the local oscillator signal at the output of the optional amplifier 312 to be coupled to the phase detector 310 to phase compare the local oscillator signal with the reference from the crystal oscillator 308, and to generate a phase error signal. The phase error signal is applied to the loop filter 313 to generate a tuning voltage V_{TUNE} for the DRO 314 to keep the DRO output within a frequency specification.

The output of the mixer 306 is coupled to an intermediate frequency (IF) filter 316 to remove the higher frequency products and other unwanted signals from the down-converted received signal. If two-stage down-conversion is desired, the output of the IF filter 316 is coupled to a second down-converting stage comprising a second mixer 320 and a second local oscillator (LO) comprising DRO 324, optional amplifier 322, a directional coupler 321, a phase detector 326 (e.g. like phase detector 100), the reference crystal oscillator 308 (being common to both down converting stages), and a loop filter 325. The output of the DRO 324 is coupled to the input of the optional amplifier 322 for increasing the power of the local oscillator signal sufficiently to drive the mixer 320. The output of optional amplifier 322 is coupled to the input of the directional coupler 321 to provide a portion of the local oscillator signal at the output of the optional amplifier 322 to be coupled to the phase detector 326 to phase compare the local oscillator signal with the reference from the crystal oscillator 328, and to generate a phase error signal. The phase error signal is applied to the loop filter 325 to generate the tuning voltage V_{TUNE} for the DRO 324 to keep the DRO output within a frequency specification. The output of the mixer 320 is coupled to a baseband filter 330 to remove the higher frequency products and other unwanted signals from the second down-converted received signal to generate a baseband signal.

FIG. 4 illustrates a block diagram of an exemplary transmitter 400 using a phase detector in accordance with the invention. The phase detector 100 of the invention can be used in many applications, even as part of the transmitter 400. The transmitter 400 comprises a first up-converting stage for up-converting a baseband signal. The first up-converting stage comprises a first mixer 402 and a first local oscillator (LO) comprising DRO 410, optional amplifier 408, directional coupler 407, phase detector 406 (e.g. like phase detector 100), a reference crystal oscillator 404, and a loop filter 409. The output of the DRO 410 is coupled to the input of the optional amplifier 408 for increasing the power of the local oscillator signal sufficiently to drive the mixer 402. The output of optional amplifier 408 is coupled to the input of the directional coupler 407 to provide a portion of the local oscillator signal at the output of the optional amplifier 408 to be coupled to the phase detector 406 to phase compare the local oscillator signal with the reference from the crystal oscillator 404, and to generate a phase error signal. The phase error signal is applied to the loop filter 409 to generate a tuning voltage V_{TUNE} for the DRO 410 to keep the DRO output within a frequency specification.

The output of the mixer 402 is coupled to an intermediate frequency (IF) filter 412 to remove the lower frequency products and other unwanted signals from the up-converted signal. If two-stage up-conversion is desired, the output of the IF filter 412 is coupled to a second up-converting stage comprising a second mixer 414 and a second local oscillator (LO) comprising DRO 418, optional amplifier 416, phase detector 420 (e.g. like phase detector 100), the reference crystal oscillator 408 (being common to both up-converting stages), and a loop filter 419. The output of the DRO 418 is coupled to the input of the optional amplifier 416 for increasing the power of the local oscillator signal sufficiently to drive the mixer 414. The output of optional amplifier 416 is coupled to the input of the directional coupler 415 to provide a portion of the local oscillator signal at the output of the optional amplifier 416 to be coupled to the phase detector 420 to phase compare the local oscillator signal with the reference from the crystal oscillator 422, and to generate a phase error signal. The phase error signal is applied to the loop filter 419 to generate a tuning voltage V_{TUNE} for the DRO 418 to keep the DRO output within a frequency specification.

The output of the mixer 414 is coupled to a radio frequency (RF)/microwave/millimeterwave filter 424 to remove the lower frequency products and other unwanted signals from the second up-converted signal to generate the RF/microwave/millimeterwave signal for transmission via a wireless medium or other transmission medium. The output of the RF/microwave/millimeterwave filter 424 is coupled to the input of a power amplifier 426, which may comprise of one or more amplifier stages, for increasing the power of the RF/microwave/millimeterwave signal for transmission over the wireless medium via the antenna 428 or transmission over other types of transmission mediums.

In the foregoing specification, the invention has been described with reference to specific embodiments thereof. It will, however, be evident that various modifications and changes may be made thereto departing from the broader spirit and scope of the invention. The specification and drawings are, accordingly, to be regarded in an illustrative rather than a restrictive sense.

It is claimed:

1. A phase detector for generating a phase error signal indicative of a phase difference between a reference signal and an oscillator signal, comprising:
an amplifier to convert said reference signal to a substantially square wave signal; and
a sampling phase detector to generate said phase error signal from said substantially square-wave signal and said oscillator signal.

2. The phase detector of claim 1, wherein said amplifier comprises a saturated amplification stage.

3. The phase detector of claim 1, wherein said amplifier comprises a first saturated amplification stage and a second saturated power amplification stage.

4. The phase detector of claim 1, further comprising a transformer to convert a single output of said amplifier to a balanced output.

5. The phase detector of claim 4, wherein said balanced output have impedances that substantially match the respective input impedances of said sampling phase detector.

6. The phase detector of claim 1, wherein said amplifier comprises balanced outputs.

7. The phase detector of claim 1, wherein said sampling phase detector includes a balanced output.

8. The phase detector of claim 7, wherein said balanced output of said sampling phase detector are respectively coupled to opposite ends of a potentiometer, wherein said phase error signal is generated at a wiper contact of said potentiometer.

9. A method of generating a phase error signal indicative of a phase difference between a reference signal and an oscillator signal, comprising:
converting said reference signal to a harmonic-rich signal having a rising and/or falling edge; and
generating said phase error signal from said harmonic-rich signal and said oscillator signal.

10. The method of claim 9, wherein said harmonic-rich signal is a substantially square-wave signal.

11. The method of claim 9, wherein converting said reference signal is performed by a saturated amplifier.

12. The method of claim 9, wherein converting said reference signal is performed by a first saturated amplification stage and a second saturated power amplification stage.

13. The method of claim 9, further comprising converting said harmonic-rich signal to first and second harmonic-rich signals cycling with substantially opposite phases.

14. The method of claim 13, wherein said phase error signal is generated from said first and second harmonic-rich signals.

15. The method of claim 9, wherein generating said phase error signal comprises:
generating first and second phase error signals having substantially opposite phases; and
adding respective weighted portions of said first and second phase error signals to generate said phase error signal.

16. The method of claim 15, wherein adding respective weighted portions of said first and second phase error signals is performed by a potentiometer.

17. A local oscillator, comprising:
a reference oscillator for generating a reference signal;
an oscillator for generating an oscillator signal; and
a phase detector for generating a phase error signal indicative of a phase difference between said reference signal and said oscillator signal, comprising:
an amplifier to convert said reference signal to a substantially square wave signal; and
a sampling phase detector to generate said phase error signal from said substantially square-wave signal and said oscillator signal.

18. The local oscillator of claim 17, wherein said amplifier comprises a saturated amplification stage.

19. The local oscillator of claim 17, wherein said amplifier comprises a first saturated amplification stage and a second saturated power amplification stage.

20. The local oscillator of claim 17, further comprising a transformer to convert a single output of said amplifier to a balanced output.

21. The local oscillator of claim 20, wherein said balanced output have impedances that substantially match the respective input impedances of said sampling phase detector.

22. The local oscillator of claim 17, wherein said sampling phase detector includes a balanced output.

23. The local oscillator of claim 22, wherein said balanced output of said sampling phase detector are respectively coupled to opposite ends of a potentiometer, wherein said phase error signal is generated at a wiper contact of said potentiometer.

24. The local oscillator of claim 17, wherein said oscillator comprises a dielectric resonator oscillator (DRO).

25. The local oscillator of claim 17, wherein said reference oscillator comprises a crystal oscillator.

26. A receiver or transmitter having at least one frequency conversion stage, wherein said frequency conversion stage comprises:
a mixer; and
a local oscillator for said mixer, comprising:
a reference oscillator for generating a reference signal;
an oscillator for generating an oscillator signal; and
a phase detector for generating a phase error signal indicative of a phase difference between said reference signal and said oscillator signal, comprising:
an amplifier to convert said reference signal to a substantially square wave signal; and
a sampling phase detector to generate said phase error signal from said substantially square-wave signal and said oscillator signal.

27. The receiver or transmitter of claim 26, wherein said amplifier comprises a saturated amplification stage.

28. The receiver or transmitter of claim 26, wherein said amplifier comprises a first saturated amplification stage and a second saturated power amplification stage.

29. The receiver or transmitter of claim 26, further comprising a transformer to convert a single output of said amplifier to a balanced output.

30. The receiver or transmitter of claim 29, wherein said balanced output have impedances that substantially match the respective input impedances of said sampling phase detector.

31. The receiver or transmitter of claim 26, wherein said sampling phase detector includes a balanced output.

32. The receiver or transmitter of claim 31, wherein said balanced output of said sampling phase detector are respectively coupled to opposite ends of a potentiometer, wherein said phase error signal is generated at a wiper contact of said potentiometer.

33. The receiver or transmitter of claim 26, wherein said oscillator comprises a dielectric resonator oscillator (DRO).

34. The receiver or transmitter of claim 26, wherein said reference oscillator comprises a crystal oscillator.
